(19) United States
(12) Patent Application Publication
(10) Pub. No.: US 2018/0004499 A1
(43) Pub. Date: Jan. 4, 2018

(54) METHOD AND SYSTEM FOR PROVISIONING APPLICATION ON PHYSICAL MACHINES USING OPERATING SYSTEM CONTAINERS

(71) Applicant: XEROX CORPORATION, Norwalk, CT (US)

(72) Inventors: Rahul Ghosh, Bangalore (IN); Tridib Mukherjee, Bangalore (IN); Aditya Hegde, Bangalore (IN); Varun Sharma, Kolkata (IN)

(21) Appl. No.: 15/197,808

(22) Filed: Jun. 30, 2016

(51) Int. Cl. G06F 9/445; G06F 9/50

(52) U.S. Cl. CPC G06F 8/61; G06F 9/5083

(57) ABSTRACT

A method and a system are provided for provisioning an application on one or more physical machines by use of operating system (OS) containers to resolve OS process overheads. The method includes receiving a first set of parameters and service level agreements (SLAs) of the application. The method further includes extracting a second set of parameters of each of the one or more physical machines. Further, the method includes determining a count of OS containers to deploy in parallel for each physical machine, based on the first set of parameters of the application and the second set of parameters of the each physical machine. The method further includes processing the application on the each physical machine based on at least the plurality of the determined count of OS containers such that a second provision time of the application is less or equal to the first provision time.

### TECHNICAL FIELD

The presently disclosed embodiments are related, in general, to operating system (OS) containers. More particularly, the presently disclosed embodiments are related to method and system for provisioning an application on one or more physical machines using OS containers.

### BACKGROUND

Advancements in the field of operating system containers, for the purpose of secured and simplified cloud computing, have helped to reduce the application execution time of enterprises across all business areas. The multiple applications running in parallel on same computing device in an unsecured manner may increase the execution run time and henceforth, may decrease the overall computation performance of a machine.

With an advent and development of virtual machines for executing multiple applications in parallel on a cloud based environment, there is need to have a secured isolated platform with proper partitioning time to deploy the application. As the technology is still being adopted, the operating system containers may play a significant role in providing a highly secured platform to execute multiple applications in parallel in a multi-tenant environment within a predefined time and providing a high execution speed. Therefore, an optimal provisioning strategy to process the application within a predefined time by deploying the operating system containers may be required.

Further limitations and disadvantages of conventional and traditional approaches will become apparent to those skilled in the art, through a comparison of described systems with some aspects of the present disclosure, as set forth in the remainder of the present application and with reference to the drawings.

### SUMMARY

According to embodiments illustrated herein, there may be provided a method for provisioning an application on one or more physical machines by use of operating system (OS) containers to resolve OS process overheads. The method may utilize one or more processors in a server to receive a first set of parameters and service level agreements (SLAs) of the application from a requestor-computing device, wherein the SLAs include at least a first provision time of the application. The method may further extract a second set of parameters of each of the one or more physical machines from a database server. The method may further determine an optimal count of OS containers for each physical machine, based on at least one of the first set of parameters of the application and the second set of parameters of the each physical machine, wherein at least a plurality of the determined count of OS containers are deployed in parallel in the each physical machine. The method may further provision the application on the each physical machine based on at least the plurality of the determined count of OS containers such that a second provision time of the application is less or equal to the first provision time.

According to embodiments illustrated herein, there may be provided a system that comprises one or more processors in a server configured to provision an application on one or more physical machines by use of OS containers to resolve OS process overheads. The system may further comprise one or more processors configured to receive a first set of parameters and SLAs of the application from a requestor-computing device, wherein the SLAs include at least a first provision time of the application. The system may further extract a second set of parameters of each of the one or more physical machines from a database server. The system may further determine an optimal count of OS containers for each physical machine, based on at least one of the first set of parameters of the application and the second set of parameters of the each physical machine, wherein at least a plurality of the determined count of OS containers are deployed in parallel in the each physical machine. The system may further provision the application on the each physical machine based on at least the plurality of the determined count of OS containers such that a second provision time of the application is less or equal to the first provision time.

According to embodiments illustrated herein, there is provided a computer program product for use with a computer. The computer program product includes a non-transitory computer-readable storage medium. The non-transitory computer readable medium stores a computer program code to provision an application on one or more physical machines by use of OS containers to resolve OS process overheads. The computer program code is executable to receive, by one or more processors, a first set of parameters and SLAs of the application from a requestor-computing device, wherein the SLAs include at least a first provision time of the application. The computer program code is further executable to extract a second set of parameters of each of the one or more physical machines from a database server. The computer program code is further executable to determine an optimal count of OS containers for each physical machine, based on at least one of the first set of parameters of the application and the second set of parameters of the each physical machine, wherein at least a plurality of the determined count of OS containers are deployed in parallel in the each physical machine. The computer program code is further executable to provision the application on the each physical machine based on at least the plurality of the determined count of OS containers such that a second provision time of the application is less or equal to the first provision time.

### BRIEF DESCRIPTION OF DRAWINGS

The accompanying drawings illustrate the various embodiments of systems, methods, and other aspects of the disclosure. Any person with ordinary skill in the art will appreciate that the illustrated element boundaries (e.g., boxes, groups of boxes, or other shapes) in the figures represent one example of the boundaries. In some examples, one element may be designed as multiple elements, or multiple elements may be designed as one element. In some examples, an element shown as an internal component of one element may be implemented as an external component in another, and vice versa. Further, the elements may not be drawn to scale.

Various embodiments will hereinafter be described in accordance with the appended drawings, which are provided to illustrate and not limit the scope in any manner, wherein similar designations denote similar elements, and in which:

FIG. 1 is a block diagram that illustrates a system environment in which various embodiments of a method and a system may be implemented, in accordance with at least one embodiment;

FIG. 2 is a block diagram that illustrates various components of a computing server configured to provision an application on one or more physical machines by use of operating system (OS) containers, in accordance with at least one embodiment;

FIG. 3 is a flowchart that illustrates a method to provision an application on one or more physical machines by use of operating system (OS) containers, in accordance with at least one embodiment;

FIG. 4A is a block diagram that illustrates an experimental system for benchmarking set-up, in accordance with at least one embodiment;

FIG. 4B is an exemplary graphical representation that illustrates an impact of large scale provisioning of OS containers on provisioning time, in accordance with at least one embodiment;

FIG. 4C is a graphical representation that illustrates an impact of number of service requests per unit time on operating system (OS) containers, in accordance with at least one embodiment;

FIG. 5 is a flowchart that illustrates a method of experimental run for benchmarking set-up, in accordance with at least one embodiment;

FIG. 6 is a block diagram that illustrates an exemplary system to deploy one or more applications by use of one or more OS containers on one or more physical machines, in accordance with at least one embodiment; and

FIG. 7 is a block diagram that illustrates a system environment for role specific, customized and on demand provisioning of one or more applications on one or more physical machines by use of operating system (OS) containers, in accordance with at least one embodiment.

### DETAILED DESCRIPTION

The present disclosure may be best understood with reference to the detailed figures and description set forth herein. Various embodiments are discussed below with reference to the figures. However, those skilled in the art will readily appreciate that the detailed descriptions given herein with respect to the figures are simply for explanatory purposes, as the methods and systems may extend beyond the described embodiments. For example, the teachings presented and the needs of a particular application may yield multiple alternative and suitable approaches to implement the functionality of any detail described herein. Therefore, any approach may extend beyond the particular implementation choices in the following embodiments described and shown.

References to “one embodiment,” “at least one embodiment,” “an embodiment,” “one example,” “an example,” “for example,” and so on indicate that the embodiment(s) or example(s) may include a particular feature, structure, characteristic, property, element, or limitation but that not every embodiment or example necessarily includes that particular feature, structure, characteristic, property, element, or limitation. Further, repeated use of the phrase “in an embodiment” does not necessarily refer to the same embodiment.

### Definitions

The following terms shall have, for the purposes of this application, the respective meanings set forth below.

An “application” refers to software, a task, or a workload that a requestor may wish to execute on a computing device. The application may vary in their resource requirements. For example, some applications may be memory-intensive (and thus, may require large memory space to be executed), while other applications may be CPU-intensive. In an embodiment, a type of the application may correspond to one or more of, but are not limited to, web based applications, gaming applications, analytical applications, mobile applications, and/or the like. Further, in an embodiment, an application may include one or more sub-applications. In another embodiment, the application may be segregated into the one or more sub-applications to meet the SLAs associated with the application.

A “physical machine” refers to a hardware-based device that includes at least one or more processors, one or more memories, and/or one or more other electronic components or circuitries. The physical machine may operate on one or more operating systems to perform one or more operations according to one or more programming instructions. Examples of the physical machine may include, but are not limited to, a server, a desktop computer, a laptop, a mobile phone, and/or the like.

An “operating system” refers to a collection of one or more software that may be installed on a computing device. Further, the installed operating system may be operable to manage one or more applications on the computing device or one or more other computing devices to process one or more requests of a task on the computing device or the one or more other computing devices. For example, operating systems including, but not limited to, “Unix,” “DOS,” “Android,” “Symbian,” and “Linux.”

An “operating system (OS) container” refers to a virtual environment that may group and isolate a set of processes and resources, such as central processing unit (CPU) memory, disk, and/or the like, from a host and/or any other OS container. Such isolation may ensure that the processes inside the OS container may not see the processes outside the OS container. More specifically, the OS container is the virtual environment that share kernel of a host operating system but facilitate user space isolation. Examples of OS container include Linux containers, for example, Docker™

A “first count of OS containers” refers to a count of OS containers that may be required to provision an application on one or more physical machines.

A “second count of OS containers” refers to a count of OS containers that may be currently operating or running on a physical machine.

A “third count of OS containers” refers to an optimal count of OS containers that may be deployed in parallel on a physical machine.

“Service level agreements (SLAs)” refer to terms and conditions in a contract that are associated with an application. For example, one or more SLAs associated with an application may include one or more parameters, such as a provision time, an accuracy, an expected quality, a price, and/or the like, that are required to be satisfied during/after provisioning of an application on a physical machine.

A “first set of parameters” refers to one or more parameters of an application that may be required to provision the application on a physical machine. For example, the one or more parameters of an application may include one or more of, but are not limited to, a count of OS containers required to process the application on one or more physical machines and an average load of each of the count of OS containers.

A “second set of parameters” refers to one or more parameters of a physical machine that may be utilized to determine if the physical machine is operable to provision one or more applications. For example, the one or more parameters of a physical machine may include one or more of, but are not limited to, a count of OS containers that are currently operating on a physical machine, a current load (i.e., number of service requests per unit time) on the physical machine, and an optimal count of OS containers that may be deployed in parallel on the physical machine.

A “first provision time” refers to an agreed execution time for provisioning an application on one or more physical machines. The first provisioning time may correspond to one of one or more SLAs of the application.

A “second provision time” refers to an actual execution time that one or more physical machines may require provisioning an application. The second provision time may be estimated based on one or more parameters such as, but are not limited to, at least a first count of OS containers, an average load of each OS container that corresponds to the first count of OS containers, a second count of OS containers, and a current load on each of the physical machines.

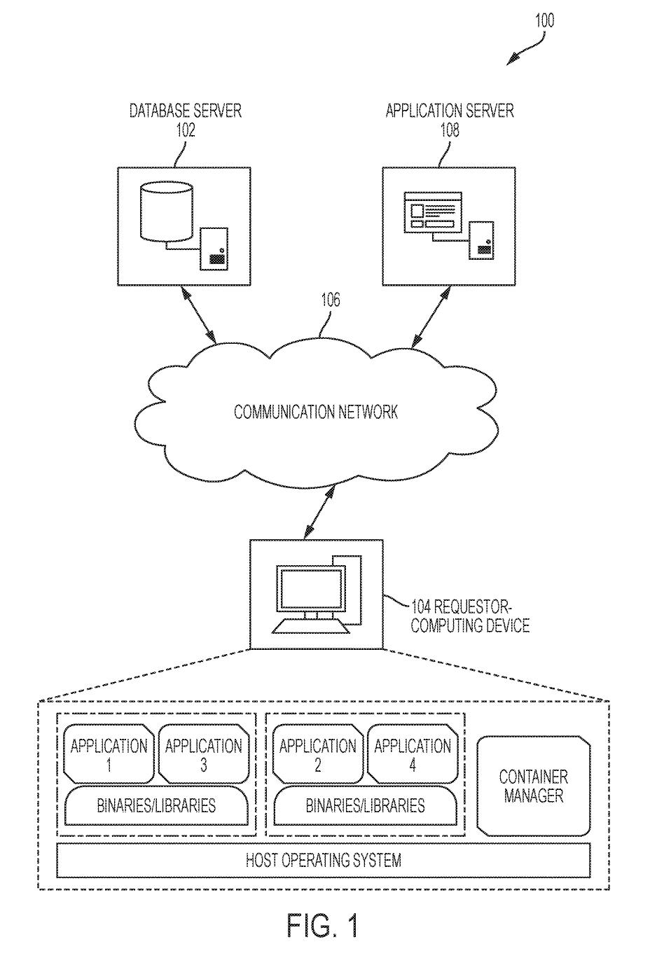

FIG. 1 is a block diagram that illustrates a system environment 100 in which various embodiments of a method and a system may be implemented. The system environment 100 may include a database server 102, a requestor-computing device 104, a communication network 106, and an application server 108. The database server 102, the requestor-computing device 104, and the application server 108 may be communicatively coupled with each other via the communication network 106.

The database server 102 may refer to a computing device or a storage device that may be configured to perform one or more database operations. The one or more database operations may include one or more of, but are not limited to, receiving, storing, processing, and transmitting one or more queries, data, or content to/from one or more computing devices, such as the requestor-computing device 104, or one or more servers, such as the application server 108. For example, the database server 102 may be configured to store one or more parameters of one or more physical machines. The one or more parameters of the one or more physical machines may include a count of OS containers that are currently operating (or running) on the one or more physical machines and a current load on each of the one or more physical machines. The one or more parameters may further include, but are not limited to, the count of OS containers that may be deployed in parallel on the one or more physical machines. In addition to the one or more parameters of the one or more physical machines, the database server 102 may be configured to store one or more requests received from the requestor-computing device 104 (or the application server 108). The one or more requests may correspond to provisioning of one or more applications on the one or more physical machines by use of one or more OS containers. The one or more requests may further include one or more parameters of the one or more applications. For example, the one or more parameters of the one or more applications may include, but are not limited to, a count of OS containers required to process the one or more applications on the one or more physical machines and an average load of each OS container that corresponds to the count of OS containers. The one or more requests may further include one or more SLAs of the one or more applications.

Further, in an embodiment, the database server 102 may store one or more sets of instructions, codes, scripts, or programs that may be retrieved by the application server 108 to perform one or more operations. For querying the database server 102, one or more querying languages may be utilized, such as, but not limited to, SQL, QUEL, and DMX. In an embodiment, the database server 102 may be realized through various technologies such as, but not limited to, Microsoft® SQL Server, Oracle®, IBM DB2®, Microsoft Access®, PostgreSQL®, MySQL® and SQLite®, and the like.

A person with ordinary skill in the art will understand that the scope of the disclosure is not limited to the database server 102 as a separate entity. In an embodiment, the functionalities of the database server 102 may be integrated into the application server 108, or vice versa.

In an embodiment, the requestor-computing device 104 refers to a computing device that may be utilized by a requestor to perform one or more operations. The requestor-computing device 104 may comprise one or more processors and one or more memories. The one or more memories may include one or more sets of computer readable codes, instructions, programs, or algorithms that may be executable by the one or more processors to perform the one or more operations. For example, a requestor may utilize the requestor-computing device 104 to initiate a provisioning of one or more applications on one or more physical machines. Further, the requestor may utilize the requestor-computing device 104 to transmit one or more requests, pertaining to the provisioning of the one or more applications on the one or more physical machines, to the database server 102 or the application server 108 over the communication network 106. Further, the requestor may transmit one or more parameters of the one or more applications to the database server 102 or the application server 108. The one or more parameters may include a count of OS containers required to process the one or more applications, such as “Application 1,” “Application 2,” “Application 3,” and “Application 4,” on the one or more physical machines, such as the requestor-computing device 104. The one or more parameters may further include an average load of each OS container that corresponds to the count of OS containers. In an embodiment, the one or more applications, an associated run-time, one or more libraries, and a container manager to determine the strategy to deploy the one or more OS containers may be installed on a host operating system of a single physical machine using the one or more OS containers. Further, the requestor may transmit one or more SLAs associated with the one or more applications to the database server 102 or the application server 108 over the communication network 106. Examples of the requestor-computing device 104 may include, but are not limited to, a personal computer, a laptop, a personal digital assistant (PDA), a mobile device, a tablet, or any other computing device.

The communication network 106 may correspond to a communication medium through which the database server 102, the requestor-computing device 104, and the application server 108 may communicate with each other. Such a communication may be performed in accordance with various wired and wireless communication protocols. Examples of such wired and wireless communication protocols include, but are not limited to, Transmission Control Protocol and Internet Protocol (TCP/IP), User Datagram Protocol (UDP), Hypertext Transfer Protocol (HTTP), File Transfer Protocol (FTP), ZigBee, EDGE, infrared (IR), IEEE 802.11, 802.16, 2G, 3G, 4G cellular communication protocols, and/or Bluetooth (BT) communication protocols. The communication network 106 may include, but is not limited to, the Internet, a cloud network, a Wireless Fidelity (Wi-Fi) network, a Wireless Local Area Network (WLAN), a Local Area Network (LAN), a telephone line (POTS), and/or a Metropolitan Area Network (MAN).

The application server 108 may refer to a computing device or a software framework hosting an application or a software service. In an embodiment, the application server 108 may be implemented to execute procedures such as, but are not limited to, the one or more sets of programs, instructions, codes, routines, or scripts stored in one or more memories for supporting the hosted application or the software service. In an embodiment, the hosted application or the software service may be configured to perform one or more predetermined operations. For example, the application server 108 may be operable to receive the one or more requests, and the associated one or more parameters and the one or more SLAs from the requestor-computing device 104 over the communication network 106.

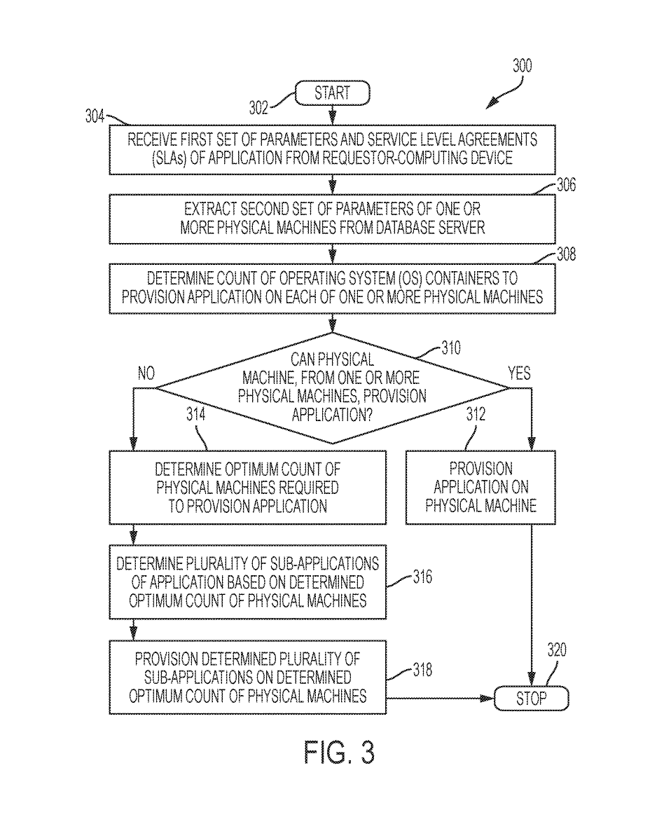

After receiving the one or more requests, the application server 108 may be operable to perform the one or more predetermined operations. For example, the one or more predetermined operations may include one or more of, but are not limited to, transmitting one or more queries to the database server 102 to extract the one or more parameters of the one or more physical parameters based on the received one or more requests and the associated one or more parameters and the one or more SLAs. Thereafter, the application server 108 may be operable to process the one or more requests based on the extracted one or more parameters of the one or more physical parameters. For example, the application server 108 may be operable to determine a count of OS containers that may be utilized to provision the one or more applications on the one or more physical machines. The determination of the count of OS containers has been explained in detail in conjunction with FIG. 3. Further, in an embodiment, the application server 108 may be operable to determine an optimum count of physical machines, from the one or more physical machines, that may be utilize to provision the one or more applications. The determination of the optimum count of physical machines has been explained in detail in conjunction with FIG. 3.

The application server 108 may be realized through various types of application servers such as, but are not limited to, a Java application server, a .NET framework application server, a Base4 application server, a PHP framework application server, or any other application server framework.

A person having ordinary skill in the art will appreciate that the scope of the disclosure is not limited to realizing the application server 108 and the requestor-computing device 104 as separate entities. In an embodiment, the application server 108 may be realized as an application program installed on and/or running on the requestor-computing device 104 without departing from the scope of the disclosure.

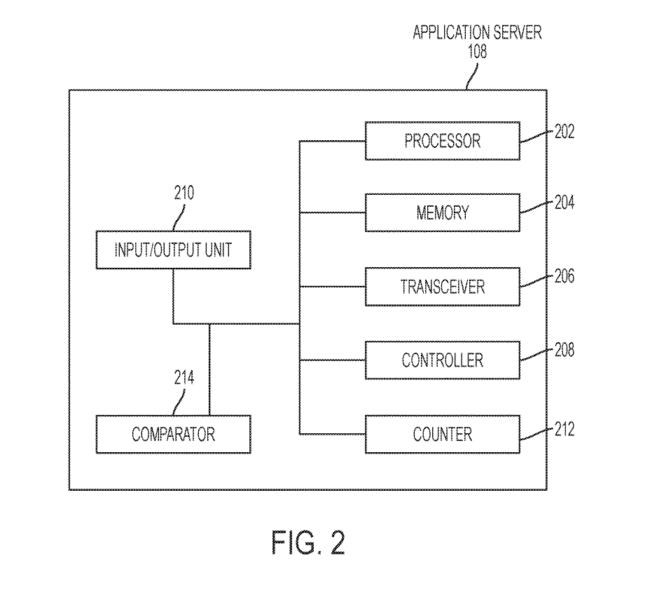

FIG. 2 is a block diagram that illustrates various components of a computing server that is configured to provision the one or more applications on the one or more physical machines by use of OS containers, in accordance with at least one embodiment. With reference to FIG. 2, there is shown the application server 108 that is described in conjunction with the elements from FIG. 1. In an embodiment, the application server 108 includes one or more processors, such as a processor 202, one or more memories, such as a memory 204, one or more transceivers, such as a transceiver 206, one or more controllers, such as a controller 208, one or more input/output units, such as an input/output (I/O) unit 210, one or more counters, such as a counter 212, and one or more comparators, such as a comparator 214.

The processor 202 comprises one or more suitable logic, circuitries, interfaces, and/or codes that may be configured to execute one or more set of instructions, programs, or algorithms stored in the memory 204. The processor 202 may be communicatively coupled to the memory 204, the transceiver 206, the controller 208, the I/O unit 210, the counter 212 and the comparator 214. The transceiver 206 may be communicatively coupled to the communication network 106. The processor 202 may be implemented based on a number of processor technologies known in the art. The processor 202 may work in coordination with the transceiver 206, the controller 208, the I/O unit 210, the counter 212 and the comparator 214 to provision the one or more applications on the one or more physical machines by use of the OS containers. Examples of the processor 202 include, but are not limited to, an X86-based processor, a Reduced Instruction Set Computing (RISC) processor, an Application-Specific Integrated Circuit (ASIC) processor, a Complex Instruction Set Computing (CISC) processor, and/or other processor.

The memory 204 comprises one or more suitable logic, circuitries, interfaces, and/or codes that may be configured to store the one or more set of instructions, programs, or algorithms, which are executed by the processor 202 to perform the one or more predetermined operations. In an embodiment, the memory 204 may be configured to store one or more programs, routines, or scripts that may be executed in coordination with the processor 202. The memory 204 may be implemented based on a Random Access Memory (RAM), a Read-Only Memory (ROM), a Hard Disk Drive (HDD), a storage server, and/or a Secure Digital (SD) card. It will be apparent to a person having ordinary skill in the art that the one or more sets of instructions, codes, scripts, and programs stored in the memory 204 may enable the hardware of the application server 108 to perform the one or more predetermined operations.

The transceiver 206 comprises one or more suitable logics, circuitries, interfaces, and/or codes that may be configured to receive or transmit the one or more queries, data, content, or other information to/from one or more computing devices (e.g., the database server 102 or the requestor-computing device 104) over the communication network 106. The transceiver 206 may implement one or more known technologies to support wired or wireless communication with the communication network 106. In an embodiment, the transceiver 206 may include, but is not limited to, an antenna, a radio frequency (RF) transceiver, one or more amplifiers, a tuner, one or more oscillators, a digital signal processor, a Universal Serial Bus (USB) device, a coder-decoder (CODEC) chipset, a subscriber identity module (SIM) card, and/or a local buffer. The transceiver 206 may communicate via wireless communication with networks, such as the Internet, an Intranet and/or a wireless network, such as a cellular telephone network, a wireless local area network (LAN) and/or a metropolitan area network (MAN). The wireless communication may use any of a plurality of communication standards, protocols and technologies, such as Global System for Mobile Communications (GSM), Enhanced Data GSM Environment (EDGE), wideband code division multiple access (W-CDMA), code division multiple access (CDMA), time division multiple access (TDMA), Bluetooth, Wireless Fidelity (Wi-Fi) (e.g., IEEE 802.11a, IEEE 802.11b, IEEE 802.11g, and/or IEEE 802.11n), voice over Internet Protocol (VoIP), Wi-MAX, a protocol for email, instant messaging, and/or Short Message Service (SMS).

The controller 208 comprises one or more suitable logics, circuitries, interfaces, and/or codes that may be configured to control the provisioning of the one or more applications on the one or more physical machines, such that the SLAs associated with the one or more applications are achieved. The controller 208 may be communicatively coupled to the processor 202, the memory 204, the transceiver 206, the I/O unit 210, and the counter 212. The controller 208 may be a plug in board, a single integrated circuit on the motherboard, or an external device. Examples of the controller 208 include, but are not limited to, graphics controller, SCSI controller, network interface controller, memory controller, programmable interrupt controller, terminal access controller, and/or the like.

The I/O unit 210 may comprise one or more suitable logics, circuitries, interfaces, and/or codes that may be operable to receive one or more requests or queries from the requestor-computing device 104. Further, the I/O unit 210 in conjunction with the transceiver 206 may be configured to transmit one or more responses pertaining to the one or more requests or queries to the database server 102 or the requestor-computing device 104 via the communication network 106. The I/O unit 210 may be operable to communicate with the processor 202, the memory 204, the transceiver 206, or the controller 208. Examples of the input devices may include, but are not limited to, a touch screen, a keyboard, a mouse, a joystick, a microphone, a camera, a motion sensor, a light sensor, and/or a docking station. Examples of the output devices may include, but are not limited to, a speaker system and a display screen.

The counter 212 comprises suitable logic, circuitry, interfaces, and/or code that may be configured to determine a count of the OS containers that is required to provision the application on the one or more physical machines. In an embodiment, the counter 212 may be realized through either software technologies or hardware technologies known in the art. Examples of the counter 212 includes one or more of, but are not limited to, an electronic counter, such as an asynchronous counter, a synchronous counter, a cascaded counter, and/or the like, a web-based counter, a computer-based counter, and/or the like.

The comparator 214 may be configured to compare at least two input signals to generate an output signal. In an embodiment, the comparator 214 compares the first provision time and the second provision time to determine the number of physical machines that is required to provision the application. In an embodiment, the comparator 214 may be realized through either software technologies or hardware technologies known in the art. Though, the comparator 214 is depicted as independent from the processor 202 in FIG. 2, a person skilled in the art will appreciate that the comparator 214 may be implemented within the processor 202 without departing from the scope of the disclosure.

FIG. 3 is a flowchart that illustrates a method to provision an application on one or more physical machines by use of one or more OS containers, in accordance with at least one embodiment. With reference to FIG. 3, there is shown a flowchart 300 that is described in conjunction with FIG. 1 and FIG. 2. The method starts at step 302 and proceeds to step 304.

At step 304, a first set of parameters and one or more SLAs of the application are received from the requestor-computing device 104. In an embodiment, the processor 202 may be configured to receive the first set of parameters and the one or more SLAs of the application from the requestor-computing device 104 over the communication network 106. In an embodiment, the first set of parameters of the application may comprise at least one or more of, but are not limited to, a first count of OS containers that are required to provision the application on the one or more physical machines and an average load of each OS container that corresponds to the first count of OS containers. Further, the one or more SLAs of the application may comprise a first provision time, a first accuracy, a first expected quality, a first provision cost, and/or the like.

Prior to the receiving of the first set of parameters and the one or more SLAs, the processor 202 may receive a request from the requestor-computing device 104 over the communication network 106. The request may correspond to the provisioning of the application on the one or more physical machines. Thereafter, the processor 202 may receive the first set of parameters and the one or more SLAs of the application from the requestor-computing device 104. Thereafter, the processor 202 may store the first set of parameters and the one or more SLAs of the application in a storage device, such as the memory 204 or the database server 102.

At step 306, a second set of parameters of each of the one or more physical machines is extracted from the storage device, such as the database server 102. In an embodiment, the processor 202 may be configured to extract the second set of parameters of each of the one or more physical machines from the storage device, such as the database server 102. The second set of parameters of a physical machine may comprise one or more of, but are not limited to, a second count of OS containers that are currently operating on the physical machine, a current load on the physical machine, and a third count of OS containers that may be deployed in parallel on the physical machine. In an embodiment, the processor 202 may transmit the one or more queries to the database server 102 to extract the second set of parameters associated with each of the one or more physical machines. Thereafter, the processor 202 may store the extracted second set of parameters in the memory 204.

Further, in an embodiment, the processor 202 may determine a provisioning time (i.e., the second provisioning time) of the application using a count of OS containers per application (n_{ca}), an application load in number of requests/second (λₐₚₚ), a count of OS containers that are currently running on a physical machine (n_{ce}) and existing load on the physical machine (λe). In an illustrative scenario, the processor 202 may utilize the relation (denoted by equation-1) to determine the second provisioning time.

g(E[Yₐₚₚ])=b₀+b₁.n_{ca}+b₂.n_{ce}+b₃.λₐₚₚb₄λₑ (1)

where,

Yₐₚₚ corresponds to the random variable denoting the application provisioning time;

E[Yₐₚₚ]=μₐₚₚ corresponds to the mean of Yₐₚₚ; and

g (:) is a link function that may describe how the mean depends on the linear predictor, b₀, b₁, b₂, b₃, b₄ are the unknown parameters that may be learned from the data and may be extracted from the database server 102.

Further, an Akaike Information Criteria may be used to determine the application provisioning time. With reference to equation-1, the right hand side of the equation-1, which is a linear combination of variables, corresponds to the provisioning time being a linear function of variables. In an alternative embodiment, the right hand side of the equation-1, may be a non-linear combination of variables that corresponds to the provisioning time being a non-linear function of variables. Thus, the link function “g (:)” allows a multitude of exponential family of distributions, such as Poisson, Gaussian (normal), Binomial and Gamma distributions.

At step 308, the count of OS containers to provision the application on the one or more physical machines is determined. In an embodiment, the processor 202 may be configured to determine the count of OS containers to provision the application on the one or more physical machines. In an embodiment, the processor 202 may determine the count of OS containers based on at least the first set of parameters and the second set of parameters.

In an embodiment, the processor 202 may be configured to process or execute one or more sets of programs, instructions, pseudo codes, or algorithms to determine the count of OS containers. In an exemplary scenario, the processor 202 may be configured to utilize the following one or more pseudo codes (represented as algorithm-1) to determine the count of OS containers to provision the application on one physical machine:

| | |
|---|---|
| 1. | declare cₘᵢₙ, cₘₐₓ, c_{mid}: variables denoting a count of OS |
| | containers; |
| 2. | declare dₐₚₚ: a variable denoting an application provisioning |
| | time (i.e., a second provision time); |
| 3. | declare λₛ: a variable denoting a load; |
| 4. | if n_{ca} < n_{cu}: cₘₐₓ ← n_{ca}; else: cₘₐₓ←n_{cu}; |
| 5. | cₘᵢₙ ← 1; n_{cp}← 0; c_{mid} ← cₘₐₓ |
| 6. | while cₘᵢₙ ≦ cₘₐₓ: |
| 7. | c_{mid} ← ┌(cₘᵢₙ + cₘₐₓ)/2┐; λₛ ← λₐ * c_{mid}; |
| 8. | dₐₚₚ ← estimate_provisioning_time (λₑ, λₛ,c_{mid},n_{ce}); |
| 9. | if dₐₚₚ > dₛₗₐ: cₘₐₓ← c_{mid} − 1; |
| 10. | else if dₐₚₚ < dₛₗₐ: n_{cp} ← c_{mid}; cₘᵢₙ ← c_{mid} + 1; |
| 11. | else: n_{cp} ← c_{mid}; return c_{mid}; |
| 12. | return n_{cp}. |

where,

n_{ca} corresponds to a count of OS containers per application (i.e., a first count of OS containers);

λₐ corresponds to an average load of each container that corresponds to the first count of OS containers;

dₛₗₐ corresponds to an SLA on a provisioning time of the application (i.e., the first provision time);

n_{ce} corresponds to a count of OS containers that are currently running on a physical machine (i.e., the second count of OS containers);

λₑ corresponds to an existing load on the physical machine (i.e., the current load on the physical machine);

n_{cu} corresponds to an upper bound on a parallel provisioning strategy (i.e., the third count of OS containers); and

n_{cp} corresponds to a count of OS containers that may be deployed in parallel on the physical machine to provision the application.

Similarly, the processor 202 may further be configured to determine the count of OS containers (n_{cp}) for each of the remaining one or more physical machines.

At step 310, a check is performed to determine whether one physical machine, from the one or more physical machines, can provision the application. In an embodiment, the processor 202 may be configured to check whether the one physical machine, from the one or more physical machines, can provision the application. In an embodiment, if the processor 202 determines that the one physical machine may provision the application, then control passes to step 312. In an embodiment, if the processor 202 determines that the one physical machine may not provision the application, then control passes to step 314.

At step 312, the application is provisioned on the one physical machine. In an embodiment, the processor 202 may be configured to provision the application on the one physical machine. Prior to the provisioning of the application on the one physical machine, the processor 202 may be configured to select the one physical machine from the one or more physical machines. In an embodiment, the processor 202 may select the one physical machine from the one or more physical machines based on at least one of the determined count of OS containers and the second provisioned time associated with each of the one or more physical machines. For example, a provision time of an application is “dₛₗₐ” and the application is required to be provision on a physical machine. Let us consider that there are three physical machines, say “PM1,” “PM2,” and “PM3.” Based on the one or more pseudo codes, as discussed above, the processor 202 determines a provision time to provision the application on each of the three physical machines (“PM1,” “PM2,” and “PM3”) to be as “dₐₚₚ1,” “dₐₚₚ2,” and “dₐₚₚ3,” such that each of “dₐₚₚ1,” “dₐₚₚ2,” and “dₐₚₚ3” is less than “dₛₗₐ” and “dₐₚₚ1>dₐₚₚ2>dₐₚₚ3.” Further, the processor 202 determines that a count of OS containers to provision the application on each of the three physical machines (PM1, PM2, and PM3) to be as “n_{cp}1,” “n_{cp}2,” and “n_{cp}3,” such that “n_{cp}1>n_{cp}2>n_{cp}3.” In such a scenario, the processor 202 may select the one physical machine from the three physical machines (“PM1,” “PM2,” and “PM3”) based on either the determined provision time or the determined count of OS containers, or a combination thereof.

At step 314, an optimum count of physical machines required to provision the application is determined. In an embodiment, the processor 202 may be configured to determine the optimum count of physical machines required to provision the application. Prior to the determination of the optimum count of physical machines, the processor 202 may be configured to process or execute one or more sets of programs, instructions, pseudo codes, or algorithms to determine the count of OS containers that is required to provision the application on at least a plurality of physical machines. In an exemplary scenario, the processor 202 may be configured to utilize the following one or more pseudo codes (represented as algorithm-2) to determine the count of OS containers to provision the application on the plurality of physical machines:

| | |
|---|---|
| 1. | declare nᵣₑₛₜ, nₚᵣₒᵥ, nₘₐₓ: variables denoting a count of |
| | containers; |
| 2. | declare j, jₘₐₓ: variable denoting one or more physical |
| | machines; |
| 3. | declare flag: binary variable; |
| 4. | nᵣₑₛₜ ←n_{ca}; nₚᵣₒᵥ ← 0; flag ← 0; Pₚᵣₒᵥ ← { }; |
| 5. | while nₚᵣₒᵥ < n_{ca}: |
| 6. | j ← 1; nₘₐₓ ← 0; jₘₐₓ ← 0; |
| 7. | while j ≦ mᵣ: |
| 8. | n_{cp}^{(j)} ← algorithm-1(n_{ca}, λₐ,dₛₗₐ, n_{ce}^{(j)}, λₑ^{(j)}, n_{cu}); |
| 9. | if (n_{cp}^{(j)}! = 0) and (n_{cp}^{(j)} > nₘₐₓ): nₘₐₓ ← n_{cp}^{(j)}; jₘₐₓ ← j; |
| 10. | j ← j + 1 |
| 11 | if jₘₐₓ == 0: flag ← 1; break; |
| 12. | nₚᵣₒᵥ ← nₚᵣₒᵥ + nₘₐₓ; nᵣₑₛₜ ← nᵣₑₛₜ − nₚᵣₒᵥ; |
| 13. | add (jₘₐₓ, nₘₐₓ) to Pₚᵣₒᵥ; |
| 14. | if (flag== 1): Add (mᵣ + 1 , nᵣₑₛₜ) to Pₚᵣₒᵥ; |
| 15. | return Pₚᵣₒᵥ. |

where,

n_{ca} corresponds to a count of OS containers per application (i.e., a first count of OS containers);

λₐ corresponds to an average load of each container that corresponds to the first count of OS containers;

dₛₗₐ corresponds to an SLA on a provisioning time of the application (i.e., the first provision time);

n_{ce}^{(j)} corresponds to a count of OS containers that are currently running on a j^{th} physical machine (i.e., the second count of OS containers);

λₑ^{(j)} corresponds to an existing load on j^{th} physical machines (i.e., the current load on the j^{th} physical machines);

n_{cu} corresponds to an upper bound on a parallel provisioning strategy (i.e., the third count of OS containers);

{1, . . . , mᵣ} corresponds to the set of running physical machines; and

{mᵣ+1, . . . , m} corresponds to the set of turned off physical machines.

Based on at least the execution of the one or more pseudo codes (represented as algorithm-2), the processor 202 may determine the count of OS containers to provision the application on the plurality of physical machines. Further, the processor 202 may select the plurality of physical machines from the one or more physical machines such that the SLAs (e.g., the first provision time) of the application are satisfied. For example, the processor 202 may select the plurality of physical machines such that a sum of a provisioning time (i.e., a second provisioning time) associated with each of the plurality of physical machines is less than the first provisioning time. In an embodiment, the plurality of physical machines may correspond to the optimum count of physical machines.

At step 316, a plurality of sub-applications of the application is determined based on the determined optimum count of physical machines. In an embodiment, the processor 202 may be configured to determine the plurality of sub-applications of the application based on the determined optimum count of the physical machines. The processor 202 may utilize one or more techniques, known in the art, to determine the plurality of sub-applications when a parallel deployment of said count of OS containers, to jointly partition and provision said application, requires at least one another physical machine. In an embodiment, a count of the plurality of sub-applications may correspond to an optimal count of sub-applications that may be deployed on the determined optimum count of the physical machines using OS containers. For example, consider an application represented as “app-1” with a first provisioning time as “dₛₗₐ.” The processor 202 determines that the provisioning of the application “app-1” requires three physical machines. In such a scenario, the processor 202 may be configured to determine three sub-applications. With respect to the ongoing example, the processor 202 may determine three sub-applications as “sub-app1,” “sub-app2,” and “sub-app3,” having a provision time of “dₛₗₐ1,” “dₛₗₐ2,” and “dₛₗₐ3,” respectively, such that (dₛₗₐ1+dₛₗₐ2+dₛₗₐ3)≦dₛₗₐ.

At step 318, the plurality of sub-applications is provisioned on the optimum count of physical machines. In an embodiment, the processor 202 may be configured to provision the plurality of sub-applications on the optimum count of physical machines. Control passes to end step 320.

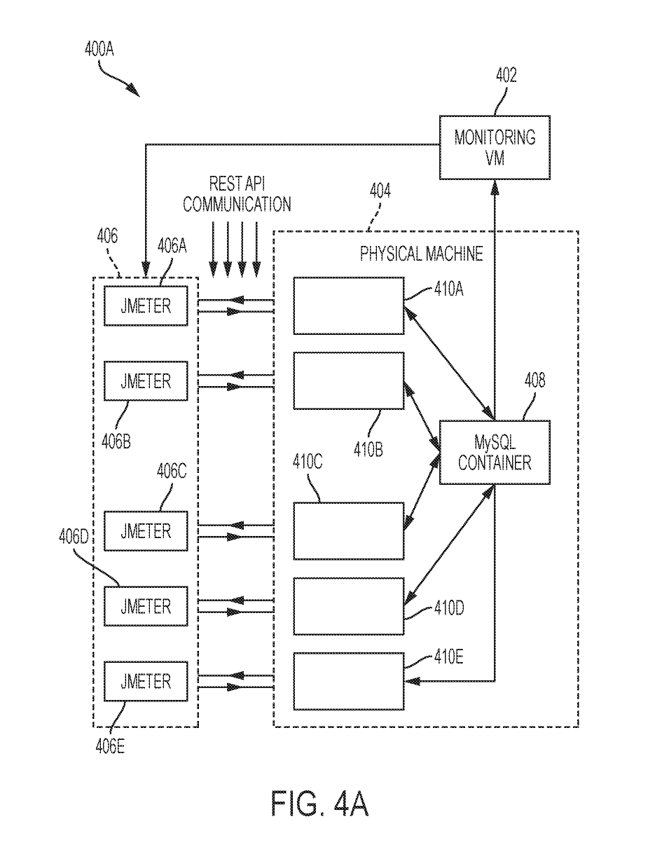

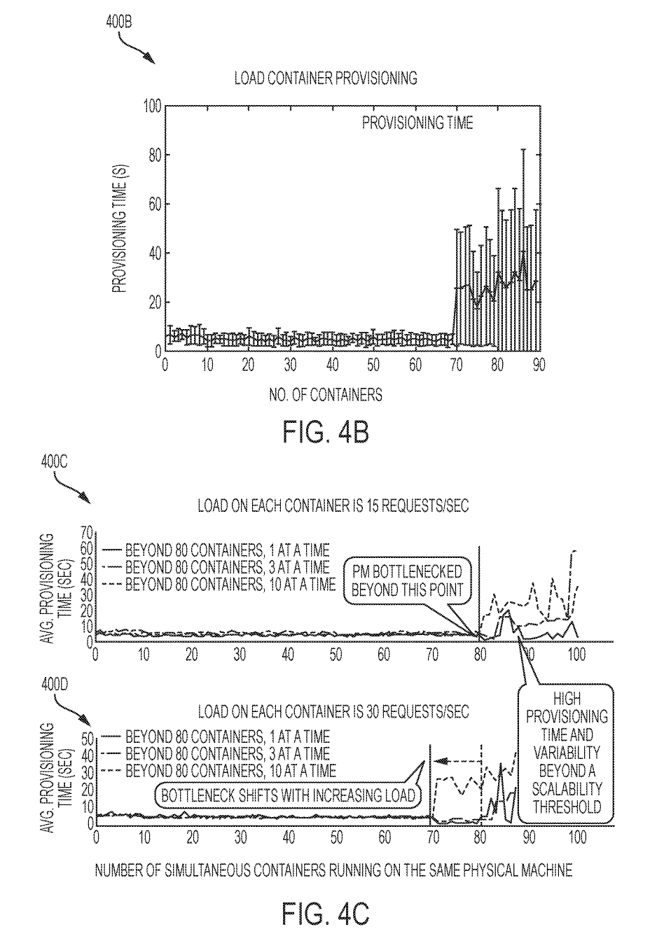

FIG. 4A is a block diagram that illustrates an exemplary system for benchmarking set-up. With reference to FIG. 4A, there is shown an exemplary system 400A for the benchmarking set-up. The exemplary system 400A includes a monitoring virtual machine 402, one or more physical machines, such as a physical machine 404, and one or more JMeters (denoted by 406A, 406B, 406C, 406D, and 406E), collectively denoted as the JMeter 406. The processor 202 may be configured to create a controller based on a Java 2 Platform Enterprise Edition (J2EE) application. The J2EE controller may be configured to control various parameters of the benchmarking set-up. The controller may create multiple OS containers (e.g., Docker containers) on the one or more physical machines. Each OS container may run a Data-as-a-Service (DaaS) web service application to retrieve enterprise operational data. The DaaS containers (denoted by 410A, 4108, 410C, 410D, and 410E) may be provisioned from a modified Tomcat Docker container image. The data, to which the DaaS containers connect to, may reside in a stand-alone MySQL container (as shown in FIG. 4) provisioned on the physical machine 404. The number of parallel DaaS containers, which are provisioned simultaneously, may be provided as an input parameter to the J2EE controller. The J2EE controller may further record a provisioning time of each OS container. Additionally, the J2EE controller may spawns JMeter instances associated with each OS container. The JMeter instances mock web traffic for the respective DaaS containers based on the input parameters (e.g., requests/second, number of experiment runs, and/or the like).

In an embodiment, the data points (e.g., response time, request, response details, provisioning time of each OS container, and/or the like) may be collected and thereafter, may further be used to come up with a decision engine. The decision engine may be used to provision infrastructure for an incoming application. Each OS container may create an instance of a modified Tomcat Docker image. The modification is in the form of the addition of the Data-as-a-Service (DaaS) web service application. Further, the deployment of the container image starts the Tomcat server instance and initializes the web application. The load is generated by JMeter per second. For e.g. 5 GET calls per second, a count of containers that may be instantiated simultaneously, a number of cores that each container may be allocated and the number of repeat runs of the same experiment may be provided as input to determine the response time of the application and the future provisioning time of each container.

FIG. 4B is an exemplary graphical representation that illustrates an impact of large scale provisioning of OS containers on provisioning time, in accordance with at least one embodiment. With reference to FIG. 4B, the exemplary graphical representation (denoted by 400B) includes an x-axis and a y-axis. The x-axis corresponds to a count of OS containers and the y-axis corresponds to provisioning time for deployment of the corresponding count of OS containers. It may be observed that when the count of OS containers running on a physical machine is below a pre-determined threshold count (such as “70”), the corresponding provisioning time remain within a predictable bound (such as up to 10 s). The predictable bound may correspond to a guaranteed SLA. However, as the count of OS containers exceeds the pre-determined threshold count (i.e., “70”), the corresponding provisioning time indicates significant variation beyond the predictable bound.

FIG. 4C is an exemplary graphical representation that illustrates an impact of number of service requests per unit time on operating system (OS) containers, in accordance with at least one embodiment. With reference to FIG. 4C, a first exemplary graphical representation (denoted by 400C) includes an x-axis and a y-axis. In the exemplary graphical representation, the x-axis corresponds to a count of OS containers running in parallel on one physical machine and y-axis corresponds to an average provisioning time required to deploy the count of OS containers in parallel on one physical machine. It may be noted that when a load on each one or more OS containers is “15 requests per second,” the average provisioning time remain within a predictable bound, such as “80 OS containers.” However, as the count of OS containers exceeds the pre-determined threshold count, the corresponding provisioning time indicates significant variation beyond the predictable bound. Further, when a load on each one or more OS containers is increased, the count of OS containers that may be deployed in parallel within the SLA, on one or more physical machines may reduce.

With reference to FIG. 4C, a second exemplary graphical representation (denoted by 400D) includes an x-axis and a y-axis. Similar to the first exemplary graphical representation (denoted by 400C), the x-axis corresponds to a count of OS containers running in parallel on one physical machine and y-axis corresponds to an average provisioning time required to deploy the count of OS containers in parallel on one physical machine. It may be noted that when a load on each one or more OS containers is “30 requests per second,” the average provisioning time remain within a reduced predictable bound, such as “70 OS containers.”

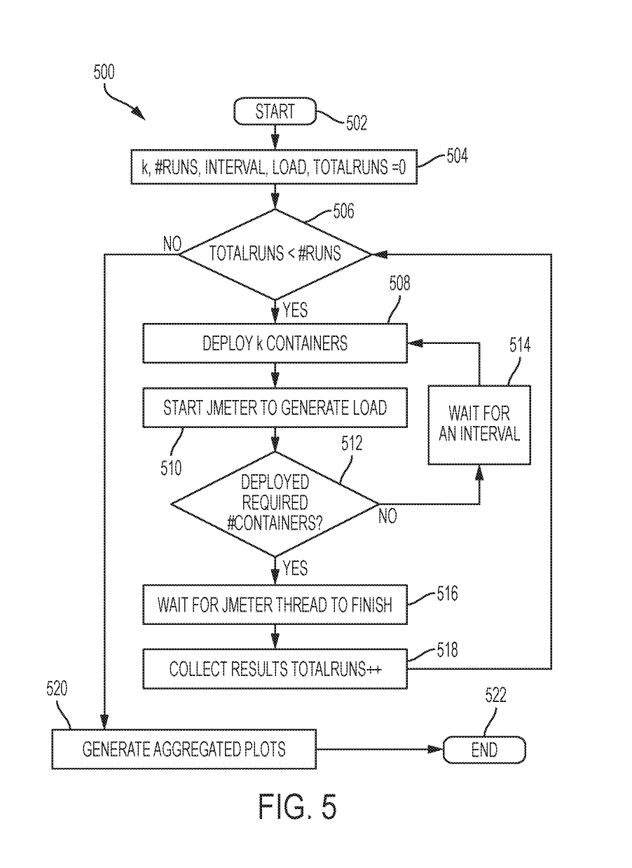

FIG. 5 is a flowchart that illustrates a method of experimental run for the benchmarking set-up. With reference to FIG. 5A, there is shown a flowchart 500 that is described in conjunction with FIG. 1A, FIG. 2, FIG. 3, and FIG. 4A. The method starts at step 502 and proceeds to step 504.

At step 504, the processor 202 may receive the first set of parameters and the SLA of the application from the requestor-computing device 104. Further, the processor 202 may extract the second set of parameters of a physical machine from the database server 102.

At step 506, a check is performed to determine whether the one or more physical machines can provision the application, based on at least a current number of total runs (“totalruns”) and a pre-defined number of runs (“#runs”) required to deploy the application on the one or more physical machines. In an embodiment, the processor 202 may be operable to perform the check based on at least the second set of parameters. If the processor 202 determines that the one or more physical machines can provision the application, then control passes to step 508 is processed, else the control passes to step 520 is processed.

At step 508, the processor 202 may deploy a pre-determined count of OS containers, such as “k”, from the determined count of OS containers, as discussed above at step 308 in conjunction with FIG. 3, on the one or more physical machines to provision the application.

At step 510, the processor 202 in conjunction with the Jmeter 406 may generate the load of each OS container that corresponds to the pre-determined count of OS containers.

At step 512, a check is performed to determine whether each of the determined count of OS containers is deployed on the one or more physical machines to provision the application within the SLA. In an embodiment, the processor 202 may be operable to perform the check based on at least the generated load. If the processor 202 determines that each of the determined count of OS containers is deployed on the one or more physical machines, then the control passes to step 516, else the control passes to step 514.

At step 514, the processor 202 may wait for a pre-defined time interval prior to the deployment of the remaining determined count of OS containers. Thereafter, the control passes to step 508.

At step 516, the processor 202 may be operable to wait for a pre-defined time interval unless the Jmeter 406 collects data on response time as observed during the entire run of the benchmarking set-up.

At step 518, the processor 202 may determine the number of total runs that may have been utilized to deploy the count of OS containers on the one or more physical machines to provision the application. Thereafter, the control passes to step 506.

At step 520, the processor 202 may be configured to generate one or more aggregated plots for the benchmarking set-up. Control passes to end step 522.

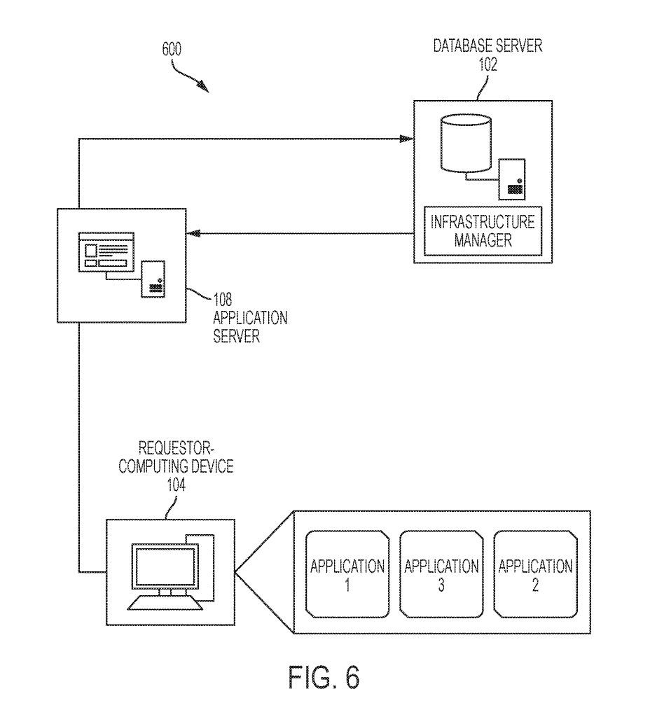

FIG. 6 is a block diagram that illustrates an exemplary system to deploy one or more applications by use of one or more OS containers on one or more physical machines, in accordance with at least one embodiment. With reference to FIG. 6, there is shown the exemplary system 600 to deploy the one or more applications by use of the one or more OS containers on the one or more physical machines. In an embodiment, the requestor may utilize the requestor-computing device 104 to transmit one or more requests, pertaining to a provisioning of the one or more applications in a specific sequence, such as “Application 1,” “Application 3,” and “Application 2,” on the one or more physical machines, to the database server 102 or the application server 108. The sequence may be determined based on the count of OS containers required to deploy the application and count of OS containers available on the physical machine. Further, the database server 102 may be configured to store one or more parameters of one or more physical machines. The one or more parameters of the one or more physical machines may include a count of OS containers that are currently operating (or running) on the one or more physical machines and a current load on each of the one or more physical machines. The one or more parameters may further include, but are not limited to, the count of OS containers that may be deployed in parallel on the one or more physical machines. The database server 102 may further include an infrastructure manager to determine a strategy to deploy the OS containers on one or more physical machines within the SLA based on the one or more parameters. Further, the application server 108 may receive the one or more requests to deploy the OS containers on one or more physical machines.

After receiving the one or more requests, the application server 108 may transmit one or more queries to the database server 102 to extract the one or more parameters of the one or more physical parameters based on the received one or more requests, the associated one or more parameters, and the one or more SLAs. Thereafter, the application server 108 may process the one or more requests based on the extracted one or more parameters of the one or more physical parameters. Based on at least the one or more requests and the current status of the one or more physical machines, the application server 108 may generate the strategy to deploy the one or more applications on the one or more physical machines.

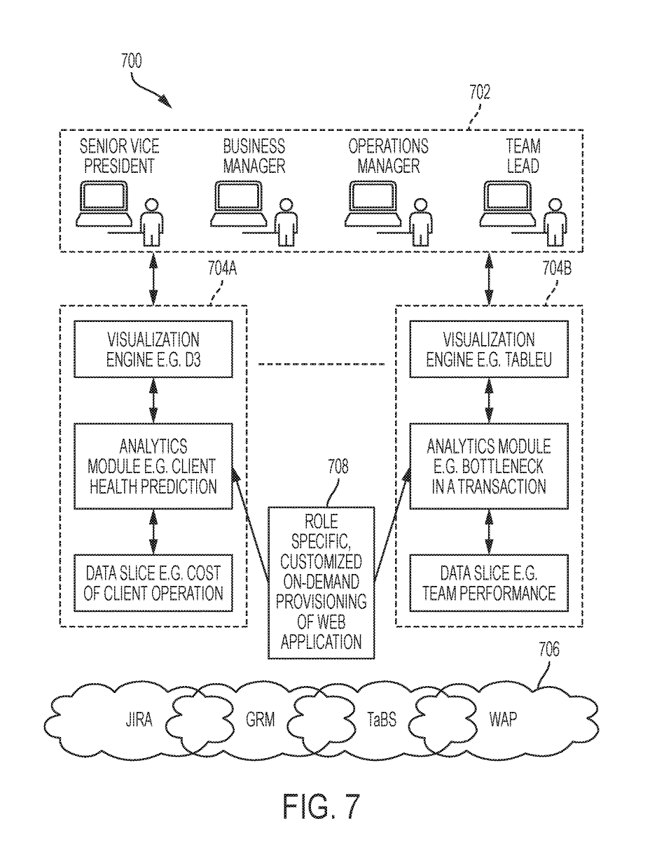

FIG. 7 is a block diagram that illustrates a system environment 700 for role specific, customized and on demand provisioning of one or more applications on one or more physical machines by use of one or more OS containers. The system environment 700 may include one or more users and associated computing devices, collectively denoted as 702, one or more applications 704A and 704B, and one or more data sources 706. For simplicity of ongoing discussion, the system environment 700 shows an instance, where several leaders within a business organization, (e.g., a senior vice president (SVP), a business manager, an operation manager, and a team lead) have been tasked with a continuous monitoring and insight generation from the one or more data sources (e.g., JIRA, GRM etc.) 706. Further, the team lead may be interested in knowing a performance of individual employees, whereas the SVP may be interested in understanding overall health condition of each of one or more employees. Further, to derive such real-time insights from a common set of the one or more data sources 706 and to cater to the needs of the several leaders (e.g., team lead, business manager etc.), a scalable platform for the role specific, customized and on demand provisioning of the one or more applications on the one or more physical machines by use of the one or more OS containers becomes essential. The system environment 700 may further maintain a state isolation among one or more installed applications because each role and several leaders within a role may have different set of requirements in terms of the data.

In another implementation of the disclosed method and the system, the request may be in an online mode from the requestor-computing device 104. In an embodiment, the one or more applications may be provisioned first on one or more active physical machines within the first provision time and then on one or more idle physical machines by use of first come first serve (FCFS) scheduling method. Further, the assignment of the one or more physical machines may be based on one or more known and intuitive heuristics such as, but are not limited to, a largest-container-first (LCF) and a largest-load-first (LLF), where the one or more physical machines with largest number of OS containers, or loads, respectively, are selected first. Similarly, the assignment of the one or more physical machines may be further based on a smallest-container-first (SCF) and a smallest-load-first (SLF), where the one or more physical machines with smallest number of OS containers, or loads, respectively, are selected first. In an embodiment, the LCF and LLF basically intend to fit the one or more physical machines as much as possible on the one or more active physical machines before provisioning on an idle physical machine. Similarly, the SCF and SLF try to balance the workload across each of the one or more physical machines.

A person skilled in the art will understand that the scope of the disclosure should not be limited to provision the one or more applications on the one or more physical machines by use of OS containers based on the aforementioned factors and using the aforementioned techniques. Further, the examples provided in supra are for illustrative purposes and should not be construed to limit the scope of the disclosure.

The disclosed embodiments encompass numerous advantages. The disclosure provides a method and a system for provisioning an application on one or more physical machines by use of OS containers. In an embodiment, the method and system may be utilized for increasing the processing speed, by determining the optimal count of OS containers to provision the application. In an embodiment, the method and the system may be utilized for increasing the processing speed by segregating the application into one or more sub applications, such that SLA (e.g., provisioning time) of the application is satisfied. Furthermore, these OS containers share a common OS and hence, they have a low resource foot-print leading to reduced provisioning time.

In an embodiment, the method and the system may be utilized to provision one or more next generation microservices based applications in parallel and further, to optimize the provisioning time to deploy microservices based application on one or more physical machines using OS containers.

The disclosed methods and systems, as illustrated in the ongoing description or any of its components, may be embodied in the form of a computer system. Typical examples of a computer system include a general-purpose computer, a programmed microprocessor, a micro-controller, a peripheral integrated circuit element, and other devices, or arrangements of devices that are capable of implementing the steps that constitute the method of the disclosure.

The computer system comprises a computer, an input device, a display unit, and the internet. The computer further comprises a microprocessor. The microprocessor is connected to a communication bus. The computer also includes a memory. The memory may be RAM or ROM. The computer system further comprises a storage device, which may be an HDD or a removable storage drive such as a floppy-disk drive, an optical-disk drive, and the like. The storage device may also be a means for loading computer programs or other instructions onto the computer system. The computer system also includes a communication unit. The communication unit allows the computer to connect to other databases and the internet through an input/output (I/O) interface, allowing the transfer as well as reception of data from other sources. The communication unit may include a modem, an Ethernet card, or other similar devices that enable the computer system to connect to databases and networks, such as, LAN, MAN, WAN, and the internet. The computer system facilitates input from a user through input devices accessible to the system through the I/O interface.

To process input data, the computer system executes a set of instructions stored in one or more storage elements. The storage elements may also hold data or other information, as desired. The storage element may be in the form of an information source or a physical memory element present in the processing machine.

The programmable or computer-readable instructions may include various commands that instruct the processing machine to perform specific tasks, such as steps that constitute the method of the disclosure. The systems and methods described can also be implemented using only software programming or only hardware, or using a varying combination of the two techniques. The disclosure is independent of the programming language and the operating system used in the computers. The instructions for the disclosure can be written in all programming languages, including, but not limited to, ‘C’, ‘C++’, ‘Visual C++’ and ‘Visual Basic’. Further, software may be in the form of a collection of separate programs, a program module containing a larger program, or a portion of a program module, as discussed in the ongoing description. The software may also include modular programming in the form of object-oriented programming. The processing of input data by the processing machine may be in response to user commands, the results of previous processing, or from a request made by another processing machine. The disclosure can also be implemented in various operating systems and platforms, including, but not limited to, ‘Unix’, ‘DOS’, ‘Android’, ‘Symbian’, and ‘Linux’.

The programmable instructions can be stored and transmitted on a computer-readable medium. The disclosure can also be embodied in a computer program product comprising a computer-readable medium, or with any product capable of implementing the above methods and systems, or the numerous possible variations thereof.

Various embodiments of the methods and systems for provisioning an application on one or more physical machines using one or more OS containers have been disclosed. However, it should be apparent to those skilled in the art that modifications in addition to those described are possible without departing from the inventive concepts herein. The embodiments, therefore, are not restrictive, except in the spirit of the disclosure. Moreover, in interpreting the disclosure, all terms should be understood in the broadest possible manner consistent with the context. In particular, the terms “comprises” and “comprising” should be interpreted as referring to elements, components, or steps, in a non-exclusive manner, indicating that the referenced elements, components, or steps may be present, or used, or combined with other elements, components, or steps that are not expressly referenced.

A person with ordinary skills in the art will appreciate that the systems, modules, and sub-modules have been illustrated and explained to serve as examples and should not be considered limiting in any manner. It will be further appreciated that the variants of the above disclosed system elements, modules, and other features and functions, or alternatives thereof, may be combined to create other different systems or applications.

Those skilled in the art will appreciate that any of the aforementioned steps and/or system modules may be suitably replaced, reordered, or removed, and additional steps and/or system modules may be inserted, depending on the needs of a particular application. In addition, the systems of the aforementioned embodiments may be implemented using a wide variety of suitable processes and system modules, and are not limited to any particular computer hardware, software, middleware, firmware, microcode, and the like.

The claims can encompass embodiments for hardware and software, or a combination thereof.

It will be appreciated that variants of the above disclosed, and other features and functions or alternatives thereof, may be combined into many other different systems or applications. Presently unforeseen or unanticipated alternatives, modifications, variations, or improvements therein may be subsequently made by those skilled in the art, which are also intended to be encompassed by the following claims.

What is claimed is:

1. A method for provisioning an application on one or more physical machines by use of operating system (OS) containers to resolve OS process overheads, said method comprising:
receiving, by one or more processors in a server, a first set of parameters and service level agreements (SLAs) of said application from a requestor-computing device, wherein said SLAs include at least a first provision time of said application;
extracting, by said one or more processors, a second set of parameters of each of said one or more physical machines from a database server; and
for each physical machine in said one or more physical machines:
determining, by said one or more processors, an optimal count of OS containers, based on at least one of said first set of parameters of said application and said second set of parameters of said each physical machine, wherein at least a plurality of said determined count of OS containers are deployed in parallel in said each physical machine; and
provisioning, by said one or more processors, said application on said each physical machine based on at least said plurality of said determined count of OS containers such that a second provision time of said application is less or equal to said first provision time.

2. The method of claim 1, wherein said first set of parameters comprises at least one of a first count of OS containers required to provision said application and an average load of each OS container that corresponds to said first count of OS containers.

3. The method of claim 1, wherein said second set of parameters of a physical machine comprises at least one of a second count of OS containers that are currently operating on said physical machine, a current load on said physical machine, and a third count of OS containers that can be deployed in parallel on said physical machine in addition to said second count of OS containers.

4. The method of claim 1, wherein said second provision time of said application is estimated, by said one or more processors, based on at least a first count of OS containers, an average load of each OS container that corresponds to said first count of OS containers, a second count of OS containers, and a current load on said each physical machine.

5. The method of claim 1 further comprising determining, by said one or more processors, a plurality of sub-applications of said application when a parallel deployment of said count of OS containers, to jointly partition and provision said application, requires at least one another physical machine.

6. The method of claim 5, wherein said plurality of sub-applications is determined based on at least a selection of an optimum count of physical machines from said one or more physical machines to provision said application.

7. The method of claim 6 further comprising determining said optimum count of physical machines based on said count of OS containers required to provision said application and a second count of OS containers that are currently operating on each of said one or more physical machines.

8. A system for provisioning an application on one or more physical machines by use of operating system (OS) containers to resolve OS process overheads, said system comprising:
one or more processors in a server configured to:
receive a first set of parameters and service level agreements (SLAs) of said application from a requestor-computing device, wherein said SLAs include at least a first provision time of said application;
extract a second set of parameters of each of said one or more physical machines from a database server; and
for each physical machine in said one or more physical machines:
determine an optimal count of OS containers, based on at least one of said first set of parameters of said application and said second set of parameters of said each physical machine, wherein at least a plurality of said determined count of OS containers are deployed in parallel in said each physical machine; and
provision said application on said each physical machine based on at least said plurality of said determined count of OS containers such that a second provision time of said application is less or equal to said first provision time.

9. The system of claim 8, wherein said first set of parameters comprises at least one of a first count of OS containers required to provision said application and an average load of each OS container that corresponds to said first count of OS containers.

10. The system of claim 8, wherein said second set of parameters of a physical machine comprises at least one of a second count of OS containers that are currently operating on said physical machine, a current load on said physical machine, and a third count of OS containers that can be deployed in parallel on said physical machine in addition to said second count of OS containers.

11. The system of claim 8, wherein said one or more processors are further configured to estimate said second provision time of said application based on at least a first count of OS containers, an average load of each OS container that corresponds to said first count of OS containers, a second count of OS containers, and a current load on said each physical machine.

12. The system of claim 8, wherein said one or more processors are further configured to determine a plurality of sub-applications of said application when a parallel deployment of said count of OS containers, to jointly partition and provision said application requires at least one another physical machine.

13. The system of claim 12, wherein said one or more processors are further configured to determine said plurality of sub-applications based on at least a selection of an optimum count of physical machines from said one or more physical machines to provision said application.

14. The system of claim 13, wherein said one or more processors are further configured to determine said optimum count of physical machines based on said count of OS containers required to provision said application and a second count of OS containers that are currently operating on each of said one or more physical machines.

15. A computer program product for use with a computer, the computer program product comprising a non-transitory computer readable medium, wherein the non-transitory computer readable medium stores a computer program code for provisioning an application on one or more physical machines by use of operating system (OS) containers to resolve OS process overheads, wherein the computer program code is executable by one or more processors in a server to:
receive a first set of parameters and service level agreements (SLAs) of said application from a requestor-computing device, wherein said SLAs include at least a first provision time of said application;
extract a second set of parameters of each of said one or more physical machines from a database server; and
for each physical machine in said one or more physical machines:
determine an optimal count of OS containers, based at least on one of said first set of parameters of said application, and said second set of parameters of said each physical machine, wherein at least a plurality of said determined count of OS containers are deployed in parallel in said each physical machine; and
provision, said application on said each physical machine based on at least said plurality of said determined count of OS containers such that a second provision time of said application is less or equal to said first provision time.
